(19) United States
(12) Patent Application Publication
(10) Pub. No.: US 2024/0131974 A1
(43) Pub. Date: Apr. 25, 2024

(54) 3D KNITTED STRUCTURE AND A METHOD OF PROVIDING A 3D KNITTED STRUCTURE

(71) Applicant: JAGUAR LAND ROVER LIMITED, Warwickshire (GB)

(72) Inventors: Belinda MASON, Whitley, Coventry, Warwickshire (GB); Sarah-Kate FRASER, Whitley, Coventry, Warwickshire (GB); Gege XU, Whitley, Coventry, Warwickshire (GB); Robert CROW, Whitley, Coventry, Warwickshire (GB)

(21) Appl. No.: 18/546,625

(22) PCT Filed: Feb. 17, 2022
(86) PCT No.: PCT/EP2022/054012

§ 371 Date: Aug. 15, 2023

(30) Foreign Application Priority Data
Feb. 18, 2021 (GB) 2102300.7

(51) Int. Cl. B60N 2/58; B60R 13/02; B60R 13/04; B60R 19/52; D04B 1/10; D04B 1/12; D04B 1/22; D04B 21/08; D04B 21/20; D06C 7/00

(52) U.S. Cl. CPC B60N 2/5891; B60R 13/0212; B60R 13/0243; B60R 13/025; B60R 13/04; B60R 19/52; D04B 1/108; D04B 1/12; D04B 1/22; D04B 21/08; D04B 21/20; D06C 7/00; D10B 2403/0332; D10B 2505/08; D10B 2505/12

(57) ABSTRACT

Aspects of the present invention relate to a method (500) of fabricating a cover for an interior trim component or an exterior trim component for a vehicle. The method comprising forming a 3D knitted structure (510) by knitting together at least one heat activated yarn and at least one non-heat activated yarn. The structure may be arranged whereby, during a subsequent heat treatment process (520) in which the cover is heated to a temperature at or above an activation temperature, the heat-activated yarn is activated thereby to form an automotive cover having a knitted structure of increased stiffness once cooled.

### TECHNICAL FIELD

The present disclosure relates to a 3D knitted structure and to a method of providing a 3D knitted structure and particularly, but not exclusively, to 3D knit structure and a method of providing a 3D knitted structure for automotive applications.

Aspects of the invention relate to a 3D knitted structure, a method of providing a 3D knitted structure, a cover comprising a 3D knitted structure, an interior trim component for a vehicle comprising a 3D knitted structure, an exterior trim component for a vehicle comprising a 3D knitted structure, and a vehicle comprising a 3D knitted structure.

### BACKGROUND

The application of 3D knitting technology in automotive applications has the potential to provide a number of advantages to automotive manufacturers. These include the capability of manufacturing of seat covers in a process producing substantially zero waste. This is because the use of 3D knitting technology may eliminate or reduce the required amount of post-production materials cutting, trimming and finishing required. It may also reduce labour costs by reducing the time required to trim a seat.

It is an aim of the present invention to address one or more of the disadvantages associated with the prior art.

### SUMMARY OF THE INVENTION

Aspects and embodiments of the invention provide a method, a cover for a vehicle, an interior trim component for a vehicle, an exterior trim component for a vehicle, and a vehicle as claimed in the appended claims

According to an aspect of the present invention there is provided a method of fabricating a cover for an interior trim component or an exterior trim component for a vehicle comprising:
forming a 3D knitted structure by knitting together at least one heat activated yarn and at least one non-heat activated yarn, the 3D knitted structure comprising at least one integrally formed 3D knitted channel comprising a substantially continuous loop of knitted material, the channel being arranged to: receive a vehicle component inserted into the channel from an end thereof; and hold the vehicle component within the continuous loop of knitted material; and applying a heat treatment process to the 3D knitted structure to form the cover.

It is to be understood that, by heat activated yarn, is meant a yarn formed from a material that melts when heated to an activation temperature of the yarn. The heat activated yarn comprise a thermoplastic material. In some embodiments the heat activated yarn may consist of a thermoplastic material. It should be understood that by applying a heat treatment process to the 3D knitted structure to form the cover, the cover is fabricated.

It is to be understood that the non-heat activated yarn may be such that it does not comprise a thermoplastic polymer. Alternatively, the non-heat activated yarn may comprise a thermoplastic polymer having a melting temperature greater than that of the heat activated yarn such that the non-heat activated yarn is not adversely affected by heating to the activation temperature of the heat activated yarn.

The structure may be arranged whereby, during the heat treatment process in which the cover is heated to a temperature at or above an activation temperature, the heat-activated yarn is activated thereby to form an automotive cover having a knitted structure of increased stiffness once cooled.

Embodiments of the present invention have the advantage that, because the cover is formed by 3D knitting, it may be produced substantially in the shapeform in which it is provided for a finished vehicle. Thus, embodiments of the present invention may reduce or substantially eliminate post-production materials cutting, trimming and/or finishing. It may also reduce labour costs by reducing the time required to trim the cover or portion thereof, which may for example be a cover for a seat or portion thereof.

It is to be understood that, in some arrangements the vehicle component may be provided within the channel prior to or after a heat treatment process applied to the cover to cause activation of the heat activated yarn. The vehicle component may comprise a cable such as a cable carrying electrical signals, a cable carrying an optical signal, a cable carrying electrical power or any other suitable cable. Alternatively, or in addition, the vehicle component may comprise a structural component such as a wire, for example a structural wire for stiffening, strengthening and/or shaping the cover formed from the cover preform, or other structural component.

It is to be understood that the provision of a channel for electrical or optical cabling has the advantage that additional cable management accessories that might otherwise be required such as clips, fixings or conduit may not be required to be installed.

In an embodiment, the method comprises forming at least one of said at least one channel in the form of a plurality of spaced channel portions.

This feature has the advantage that connection may be made to a cable, such as an electrical or optical cable, at locations between channel portions more readily. Gaps between channel portions may be provided at locations corresponding to electrical components to which connection is required to be made, such as switches, motors or other actuators, audio equipment, video equipment, displays or lamps.

In an embodiment, the method comprises providing at least one of said at least one channel on an underside of the automotive cover.

In an embodiment, the method comprises providing an electrical or optical cable through at least one of said at least one channel.

In an embodiment, the method comprises providing a structural element through at least one of said at least one channel and securing the structural element to a portion of a vehicle structure whereby the structural element is arranged to apply a tensile force to the cover.

This feature has the advantage that the cover may be caused to retain a desired shape in use, reducing a risk that the cover loosens over time or that creases form therein. In some embodiments, the cover may be a cover for a portion of an interior trim component for a vehicle such as a seat cover for a seat cushion. The structural element may be secured to a portion of the seat such as a frame of the seat. Alternatively the cover may be for a portion of an exterior trim item for a vehicle.

The structural element may be a wire, a cable, a rod or any other suitable element.

In an embodiment, the method comprises mounting the cover to a former such that the cover assumes a required shapeform, the method comprising performing the heat treatment process with the cover mounted to the former.

In an embodiment, the method comprises holding at least a portion of the cover in a required position by means of gripping means during the heat treatment process.

In an embodiment, the method comprises providing a structural element through the at least one channel and applying a tensile force to the cover during the heat treatment by applying a tensile force to the structural element.

As noted above, the structural element may be a wire, a cable, a rod or any other suitable element.

In an embodiment, the method comprises forming the cover to have an elongate rib portion, whereby the cover has a greater thickness along the rib portion.

In an embodiment, the method comprises forming the cover to have a lower density in at least one region relative to at least one other region.

In an embodiment, the method comprises forming the cover to have a more open 3D knitted structure in at least one region relative to at least one other region.

It is to be understood that a region of reduced density and/or more open 3D knitted structure may be provided at a location of the cover corresponding to a region of a finished automotive cover through which it is desirable for sound to pass with reduced attenuation by the cover, or through which it is desirable for air to pass more freely, for example for ventilation purposes. By way of example, in some embodiments a region of a cover that is to be heat treated to form a seat headrest cover may be provided with reduced density in a portion corresponding to a location at which sound from one or more audio speakers of the headrest will pass through the cover, so as to permit sound to pass through the cover to the user's ear with less attenuation by the cover. In some embodiments a region of the cover may be provided with a more open or porous structure, so as to facilitate passage of sound or air through the structure following heat treatment.

In an embodiment, wherein the heat treatment process comprises heating the 3D knitted structre to a temperature at or above an activation temperature of the heat activated yarn at which the heat-activated yarn melts, whereby upon cooling the 3D knitted structure is of increased stiffness.

In an embodiment, the heat activated yarn is arranged to melt at a temperature in the range from 80 to 150 C.

In an embodiment, the heat activated yarn is arranged to melt at a temperature in the range from 100 to 130 C, optionally in the range from 110 to 125 C, optionally at a temperature of substantially 120 C.

Other melting temperatures may be useful in some embodiments.

According to another aspect of the invention, there is provided a cover comprising a 3D knitted structure, the 3D knitted structure comprising at least one heat activated yarn and at least one non-heat activated yarn knitted together; and at least one integrally formed 3D knitted channel comprising a substantially continuous loop of knitted material, the channel being arranged to receive a vehicle component inserted into the channel from an end thereof, and hold the vehicle component within the continuous loop of knitted material.

The cover fabricated by the method according to a preceding aspect.

The structure may be arranged whereby, following a subsequent heat treatment process in which the cover is heated to a temperature at or above an activation temperature, the heat-activated yarn is activated thereby to form a cover having a knitted structure of increased stiffness.

According to a further aspect of the invention, there is provided an interior trim component comprising at least one cover according to a preceding aspect. The interior trim component may be one of for example; a seat cover; a fascia cover; a headlining; an interior pillar trim; a sun-visor; a carpet; a door card; a shelf lining; a glove-box lid; a grab handle; a centre console; any other interior trim component.

According to a further aspect of the invention, there is provided an exterior trim component comprising at least one cover according to a preceding aspect. The exterior component may be for example: a soft top for the roof of a vehicle; and/or an exterior pillar trim; and/or an external window surround; and/or another exterior trim component.

According to a still further aspect of the invention, there is provided a vehicle having at least one interior trim component and/or at least one exterior trim component according to a preceding aspect and/or at least one automotive seat according to a preceding aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic illustration of a vehicle automotive seat comprising an embodiment of the present invention in (a) side view and (b) front view;

FIG. 2 is a cross-sectional view of a former and seat cover preform during a heat treatment process to form a seat headrest cover according to the embodiment of FIG. 1;

FIG. 3 is a cross-sectional view through a portion of a seat cover preform having a rib;

FIG. 4 (a) is a cross-sectional view of a portion of a cover of a seat cushion portion of a car seat according to a further embodiment of the invention taken along line A-A of the plan view of the seat cushion portion shown in FIG. 4(b);

FIG. 5 is a schematic illustration showing examples of (a) a continuous 3D knitted channel and (b) a 3D knitted channel in the form of two spaced channel portions, the channel and channel portions being formed on an interior side of a seat cushion cover;

FIG. 6(a) is a schematic illustration of a car seat incorporating the seat cushion cover illustrated in FIG. 4;

FIG. 6(b) is a side view of the channel or channel portions illustrated in FIG. 5 with a wire tire down threaded therethrough;

FIG. 7 shows a seat cushion cover preform mounted to a former prior to a heat treatment process to form a seat cushion cover according to a further embodiment of the invention in (a) cross-sectional view and (b) plan view;

FIG. 8 shows a vehicle in accordance with an embodiment of the present invention; and

FIG. 9 shows a method of fabricating a cover for an interior trim component or an exterior trim component for a vehicle in accordance with an embodiment of the present invention.

### DETAILED DESCRIPTION

A 3D knitted automotive component and methods of fabricating such a component in accordance with embodiments of the present invention are described herein with reference to the accompanying Figures.

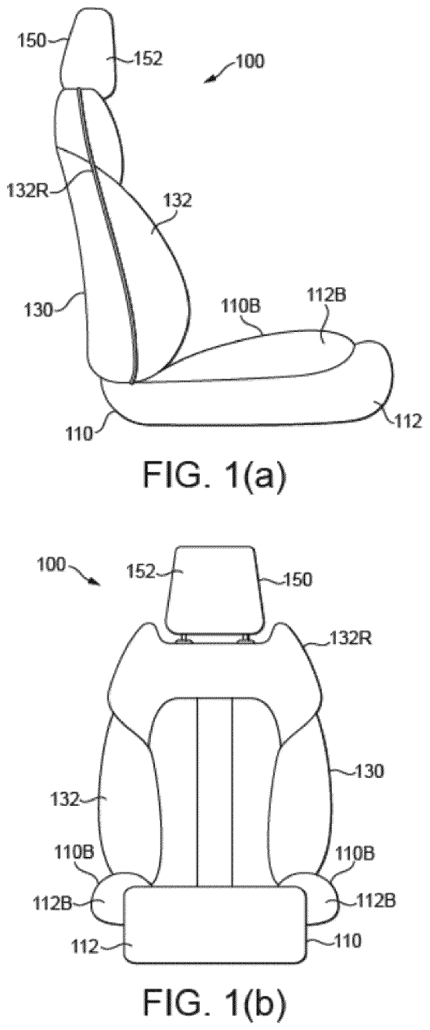

FIG. 1 is a schematic illustration of a vehicle automotive seat 100 comprising an embodiment of the present invention. FIG. 1(a) is a side view of the seat 100 whilst FIG. 1(b) is a front view.

The seat 100 comprises a cushion portion 110, a back portion 130 and a headrest portion 150. In the embodiment shown, the cushion portion is also provided with a pair of bolsters 110B along upper left and right sides thereof in order to support a users thighs. It is to be understood that the bolsters 110B may be omitted in some embodiments.

In the illustrated embodiment, the cushion portion 110, bolsters 110B, back portion 130 and head rest portion 150 are each provided with a respective cover 112, 112B, 132, 152 each being an interior trim component which has been knitted in the form of a seat cover. Each cover is formed in a process involving a 3D knitting process and a subsequent heat treatment. In some embodiments, one or more of the covers, such as the covers for the bolsters 110B, may be formed by a process other than a 3D knitting process.

In the present embodiment, the 3D knitting process is arranged to knit a number of yarns together to form a knitted cover preform having a shape corresponding to that of the final automotive knitted cover. In one embodiment, seven yarns are knitted together; five of the yarns are non-heat activated yarns comprising a polyester material and two of the yarns are heat activated yarns formed from a material that melts at a predetermined temperature during a heat treatment of the knitted cover preform. The heat treatment process fuses (bonds) both the non-heat activated yarns and heat activated yarns together to provide a stable and robust material. It is to be understood that other types of non-heat activated yarns can be used including natural yarns such as (and not limited to) wool and cotton. Other yarns, including synthetic yarns, such as nylon yarns and acrylic yarns may be used in addition or instead. It is also to be understood that other numbers of yarn may be used, and different relative proportions of non-heat activated yarn and heat activated yarn may be employed. It is to be understood that, in some embodiments, heat activated yarn is incorporated throughout the 3D knitted structure of the cover. In some alternative embodiments heat activated yarn may employed only in certain regions of the 3D knitted cover.

Once the cover 112, 112B, 132, 152 has been knitted, it is placed over a former having a shapeform corresponding to that of the portion 110, 110B, 130, 150 of the seat 100 to which the finished cover 112, 112B, 132, 152 is to be applied. Once placed over the former, the cover 112, 112B, 132, 152 is subject to a heat treatment process. The former may be formed from a plastics material, wood, metal, a composite of two or more different materials, or any other suitable material.

The heat treatment process is arranged to heat the cover 112, 112B, 132, 152 to a heat treatment temperature sufficiently high to cause activation of the heat activated yarn within a desired time period. In the present embodiment the activation temperature of the heat activated yarn is around 140 C although yarns with other activation temperatures may be employed. Activation of the heat activated yarn at the heat treatment temperature results in a change in the structure of the cover 112, 112B, 132, 152 in the regions of the cover where heat activated yarn was knitted whereby, upon cooling, these regions of the cover 112, 112B, 132, 152 have a stiffness greater than the same regions of the cover prior to the heat treatment process. In the present embodiment, at the activation temperature the heat activated yarn is arranged to melt and bind the non-heat activated yarns together upon cooling. Upon cooling, the cover 112, 112B, 132, 152 is removed from the former and fitted to the corresponding portion 110, 110B, 130, 150 of the seat 100.

It is to be understood that, as a result of performing the heat treatment of the cover 112, 112B, 132, 152, thereby increasing a stiffness thereof, the cover 112, 112B, 132, 152 will tend to remain in a shape corresponding to that of the former and therefore the portion 110, 110B, 130, 150 of the seat 100 to which it is applied upon fitting. It is to be understood that the stiffness of the cover may be adjusted by adjusting the relative proportions of non-heat activated yarn and heat activated yarn in a given region of a cover 112, 112B, 132, 152 (an increased proportion of heat activated yarn resulting in greater stiffness) and/or providing heat activated yarn only in one or more regions of a given cover 112, 112B, 132, 152.

It is to be understood that, in the present embodiment, the heat treatment applied to the cover 112, 112B, 132, 152 is a steam treatment in which the cover is exposed to steam that has been heated to a temperature sufficient to heat the cover to a temperature at which activation of the heat activated yarn takes place during the period of heat treatment.

In the present embodiment, the steam is applied to the cover 112, 112B, 132, 152 via apertures provided in the former corresponding former, the steam being arranged to pass through pores in the cover 112, 112B, 132, 152.

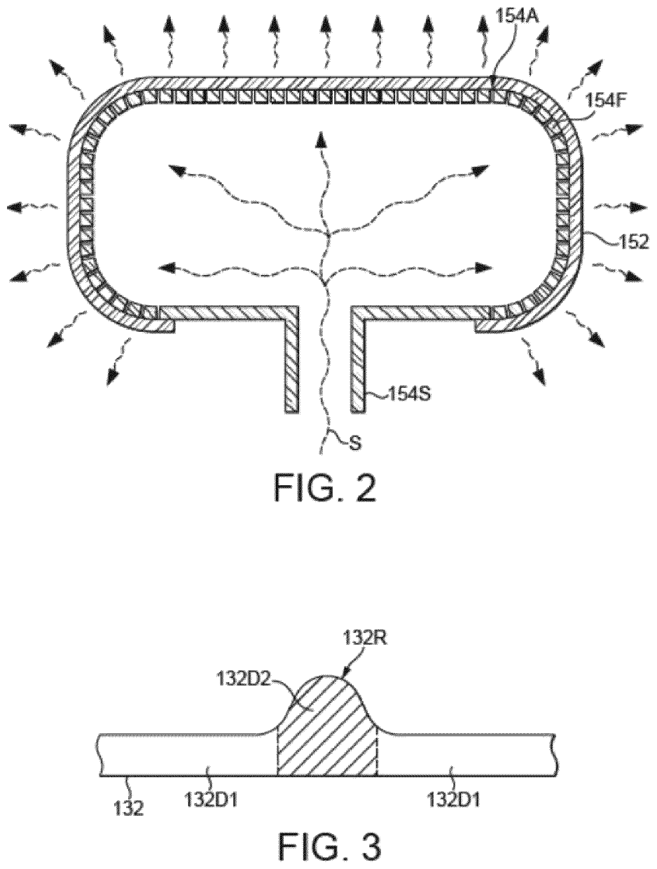

FIG. 2 illustrates the heat treatment process as applied to a headrest cover 152 during the process of forming the automotive seat 100 of the embodiment of FIG. 1. As shown in FIG. 2, the headrest cover 152 is placed over a former 154F such that an A surface of the cover 152 (that is, corresponding to the visible surface of the finished headrest cover 152, when forming part of a headrest 150) faces outwardly. The former 154F is provided with apertures 154A in the surface in contact with the headrest cover 152 through which pressurised steam S passes when supplied to the former 154F via a steam inlet 154S.

In some alternative embodiments, the cover 152 may be heated by heating the former rather than by causing steam to pass through apertures 154A in the former 154F. The former may for example be heated by means of steam or other hot gas or liquid, by means of one or more electrical heating elements or any other suitable means.

Other ways of performing a heat treatment may be employed, such as radiative heating from a heat source external to the former and the cover such as an infra-red (IR) lamp, convective heating, a combination of radiative and convective heating or any other suitable means of heating. It is to be understood that it is advantageous in the present embodiment that the cover is subjected to a heat treatment in which substantially the whole of the cover reaches the required temperature and the cover is substantially uniformly heated to prevent over-heating of any portion thereof.

It is to be understood that the choice of activation temperature for the heat-activated yarn employed to form a 3D knitted material may depend at least in part on the intended application, the composition of the non-heat activated yarn, the capabilities of the apparatus used to perform the heat treatment and operator health and safety considerations. In some embodiments, for automotive interior or exterior applications a heat activation temperature of around 120 C is advantageous, being sufficiently high that the final cover will not be unduly affected by anticipated in-service vehicle cabin temperatures, or exterior surface temperatures, and yet less hazardous to production personnel than higher temperatures. Other values of heat-activation temperature may be useful in some embodiments.

It is to be understood that, in some embodiments, the relative proportions of non-heat activated yarn and heat activated yarn may be different in some covers 112, 112B, 132, 152 relative to other covers. In some embodiments, the relative proportions of non-heat activated yarn and heat activated yarn may be different in certain areas of a given cover 112, 112B, 132, 152 compared to other areas. For example, in some embodiments the relative proportion of heat activated yarn may be higher in areas of a cover 112, 112B, 132, 152 where increased stiffness of the finished cover 112, 112B, 132, 152 is desirable.

It is to be understood that a cover 112, 112B, 132, 152 may experience shrinkage during heat treatment. The amount of shrinkage may depend on a plurality of factors such as the relative proportions of non-heat activated yarn and heat activated yarn in a given cover, a thickness of the cover and/or one or more other factors. In some embodiments the amount of shrinkage may be around 5%. It is to be understood that a size and shape of the former used to support a cover during heat treatment may be such as to provide a finished cover 112, 112B, 132, 152 of the desired size and shape following the heat treatment process.

In the embodiment of FIG. 1, the cover 132 for the seat back portion 130 has a rib 132R formed therein along the left and right sides thereof, from an upper portion of the side to a lower portion, as illustrated in FIG. 1. FIG. 3 is a cross-sectional view of the cover 132 through the rib 132R orthogonal to a direction of the rib 132R. It can be seen that the 3D knitted structure of the cover 132 has a greater thickness in the region of the rib 132R. In some embodiments the structure may, in addition or instead, have a different local mass density in the region of the rib 132R. In the embodiment of FIG. 3 the 3D knitting process is arranged such that a mass density of the rib 132R is greater in the region of the rib indicated at 132D2, compared with the adjacent regions of the cover 132, indicated at 132D1. This is so as to provide a locally increased stiffness of the rib to improve wear and/or resilience to deformation over time in service.

In some embodiments, one or more channels may be formed in a cover 112, 112B, 132, 152 during the 3D knitting process. One or more of said one or more channels may be arranged to accommodate structural elements such as tie downs formed from structural wire for holding the cover 112, 112B, 132, 152 in position or in a desired shape, such as part of the seat 100, in use. Alternatively, or in addition, one or more of said one or more channels may be arranged to act as a conduit for electrical or other cabling, for example cabling for powering and/or controlling the seat 100 or other portion of a vehicle.

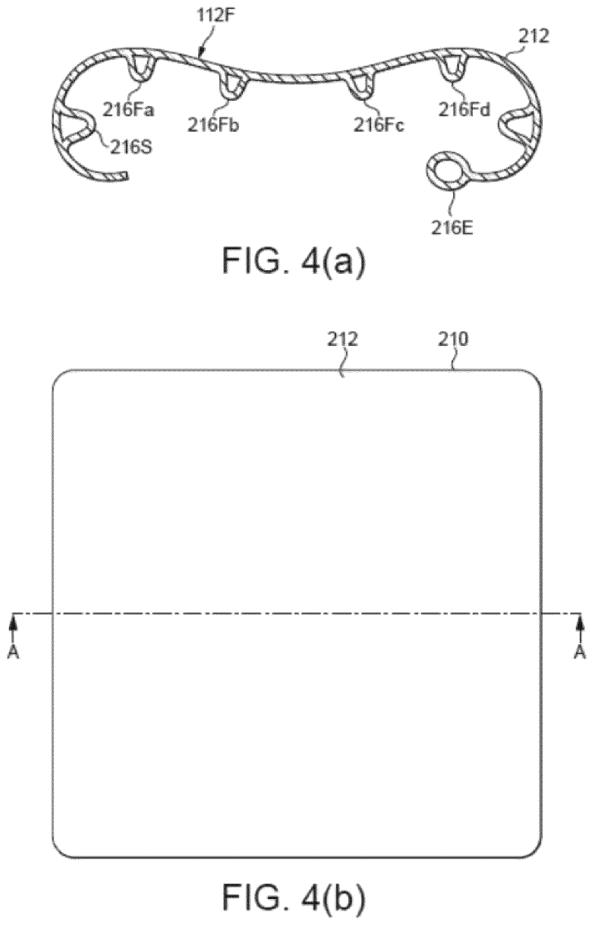

FIG. 4(a) is a cross-sectional view of a portion of a cover 212 of a seat cushion portion 210 according to an embodiment of the invention having six channels 216 formed therein. Like features of the embodiment of FIG. 4 to those of the embodiment of FIG. 1 are shown with like reference signs incremented by 100. The cross-sectional view of FIG. 4(a) is along line A-A of the plan view of the seat cushion portion 210 shown in FIG. 4(b).

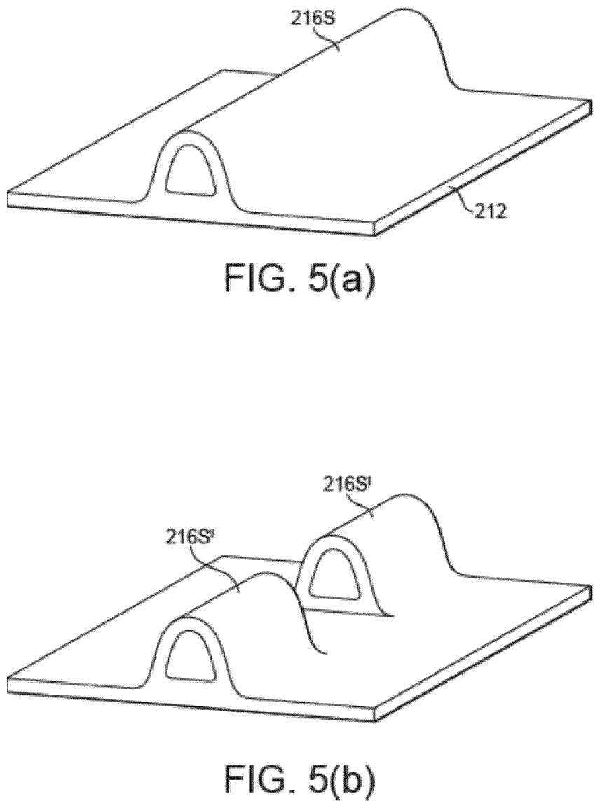

As shown in FIG. 4(a), the cover 212 has an interior side channel 216S being a channel formed on an interior surface (or ‘B surface’) of a lateral side face of the cover 212 and an edge channel 216E being a channel formed along a free edge of the cover 112. It also has four face channels 216Fa, 216Fb, 216Fc, 216Fd formed on an underside (B surface) of an outer face 112F (or ‘A surface’) of the cover 212. It is to be understood that in the embodiment of FIG. 5 the channels 216S, 216S′ are formed to have a substantially continuous surface when viewed in cross-section as shown in FIG. 4 so as to enclose a component provided therein, preventing removal of the component laterally, but not longitudinally. It is to be understood that the channels 216S, 216E, 216S′, 216Fa-d may each be provided in the form of a substantially continuous channel or provided in the form of a plurality of spaced channel portions along a desired route of a component such as a cable or other component within the cushion portion 210 of the seat. Forming the channel to have a plurality of spaced portions may for example allow electrical connection to be made more readily to a cable provided therethrough at a location between channel portions. FIG. shows an example of (a) a continuous channel 216S and (b) a channel in the form of two spaced channel portions 216S′ along an intended route of a component within the cover 212.

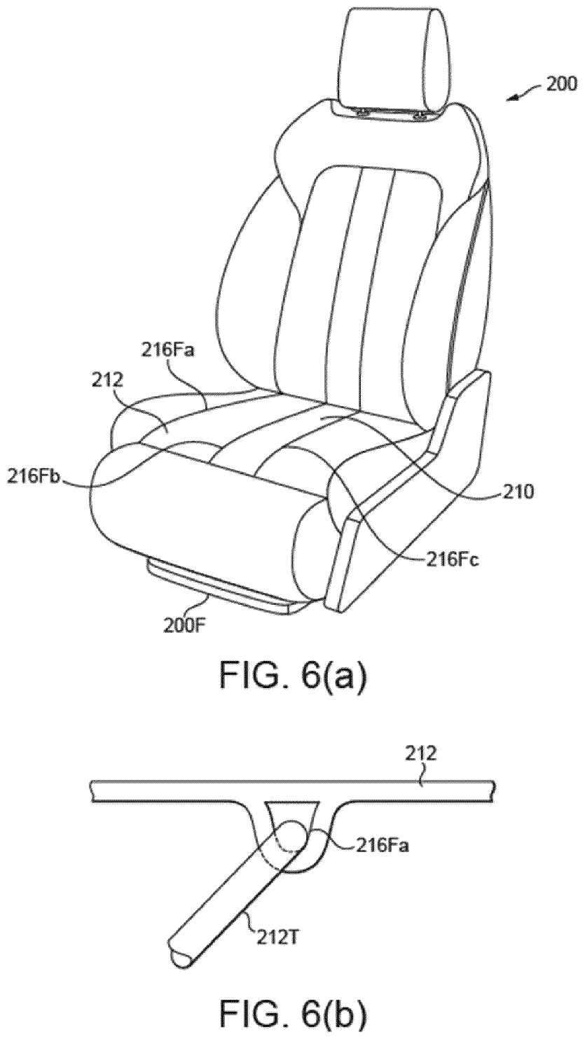

In some embodiments, in order for a 3D knitted cover to assume the desired shape for its intended application following heat treatment, it may be necessary to impose deformation on the cover 112, 112B, 132, 152, 212 during the heat treatment stage. FIG. 6 shows a car seat 200 In the present embodiment, the cushion portion 210 of the seat 200 has a concave region 110C (FIG. 1) to enhance driver comfort. During the heat treatment process applied to the cover 212 of the cushion portion 210, a region of the cover 212 is held in a concave shape as described below.

FIG. 6 (a) illustrates a seat 200 comprising an embodiment of the present invention of the cover 212 of FIG. 4. Like features of the seat 200 of FIG. 6(a) to the seat 100 of FIG. 1 are shown with like reference numerals incremented by 100.

FIG. 6 (b) illustrates a wire tie down 212T threaded through each of the face channels 216Fa-d provided on the underside of the outer face of the cover 212, the tie downs being attached at opposite ends to a frame portion 200F of the seat below the cushion portion 210. The tie downs 212T are made sufficiently taut to introduce compression into the cushion portion 210 and hold the cover 212 in place on the cushion portion 210.

In some embodiments, it may be advantageous to provide a cover having at least a portion having a concave shapeform. In some embodiments it may be advantageous to introduce concave deformation into the cover during heat treatment so as to permanently introduce the concave shapeform.

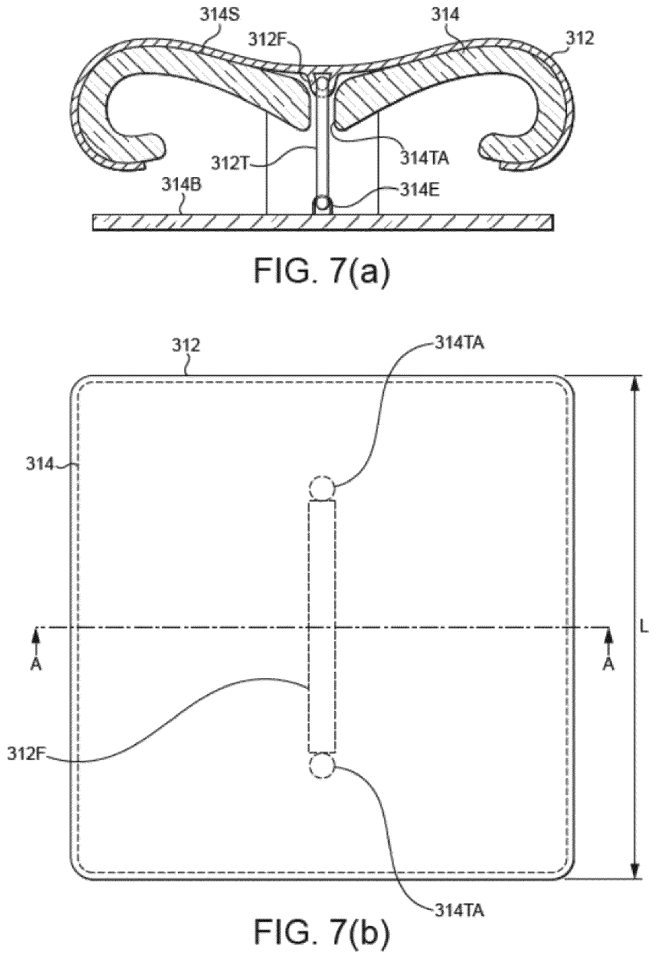

FIG. 7 shows a cover 312 for a cushion portion of a seat according to a further embodiment. Like features of the embodiment of FIG. 7 to those of the embodiment of FIG. 4 are shown with like reference numerals incremented by 100. FIG. 7(a) is a cross-sectional view along line AA of the plan view of FIG. 7(b).

The cover 312 is shown mounted over a former 314 in FIG. 7 prior to the commencement of heat treatment. An outer surface 314S of the former 314 facing the cover 312 has a concave shapeform corresponding to the shapeform that it is desired for the cover 312 to assume during the heat treatment process. In order to cause the cover 312 to conform to the shapeform of the former 314, a face channel 312F is provided on an underside of the cover 312, the face channel 312F having been formed by 3D knitting during knitting of the cover 312 as described above. The face channel 312F runs across the cover 312 from front to rear with respect to an orientation of the cover 312 when installed in a seat cushion (not shown). The face channel 312F has a length corresponding to approximately half the length L of the seat cushion as viewed in plan view on the former 314 and is provided at a location midway between opposite sides of the cover 312 as viewed in plan view.

A tie down 312T in the form of a length of wire is arranged to pass through the face channel 312F. At a location of the former 314 adjacent opposite ends of the face channel 312F when the cover 312 is in place on the former 314, apertures 314TA are provided through the former 314 through which opposite ends of the tie down 312T may be threaded and attached to tie points 314E that are provided on a base 314B of the former 314. It is to be understood that, in use, tension may be introduced into the tie down 312T sufficient to hold an underside of the cover 312 in face to face contact with the outer surface 314S of the former 314. Following the heat treatment, the tie down 312T may be released from the tie points 314E and the cover 312 removed from the former 314. It is to be understood that, in some embodiments, the cover 312 may be allowed to cool to a temperature sufficiently below the heat activation temperature to ensure that the shapeform introduced into the cover 312 by the former 314 is sufficiently retained by the cover 312 before removing the cover 312 from the former 314.

It is to be understood that the number of channels 312F provided on the inner surface of the cover 312 may be varied according to the size and complexity of the desired shapeform in order to prevent bridging by the cover 312. By bridging is meant that the cover 312 loses contact with the outer surface 314S of the former 314 over one or more areas when tension is introduced into the cover 312. Similarly, the number of apertures in the former 314 may be varied depending upon the number of tie downs employed. In some embodiments, instead of channels 312F, loops may be provided to which a tie down 312T may be attached, for example at one end of the tie down 312T, and the tie down 312T passed through an aperture 314TA in the former 314 and secured to an anchor fixing 314E as described above in order to hold the cover 312 in a desired shapeform. Other arrangements may be useful in some embodiments.

It is to be understood that, prior to the heat treatment process, the cover 312 is placed over the former 314. The tie down 312T is then pulled at opposite ends until sufficiently taut to draw the cover 312 into contact with the outer surface 314S of the former 314. The tie down 312T is then secured at opposite ends to a respective or the same tie point 314E in order to maintain the cover 312 in the desired shape during the heat treatment process.

In some embodiments, instead of employing one or more tie downs 312T, one or more regions of a cover 312 may be deformed by coupling a part of the cover 312 to the former 314 by means of a grip or clamp. The grip or clamp may for example be coupled to or integrally formed with the former 314F.

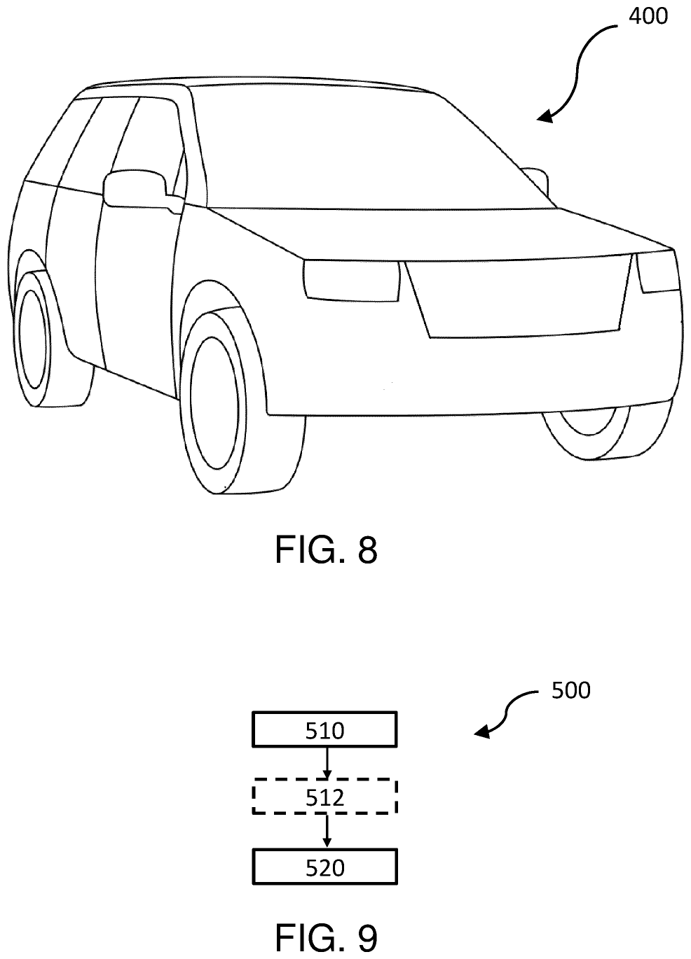

FIG. 8 illustrates an example of a vehicle 400 which comprises a 3D knitted structure as described.

It will be appreciated that various changes and modifications can be made to the present invention without departing from the scope of the present application.

For example (not shown) the cover or a portion thereof may be for a different interior trim component such as; a headlining, or an interior pillar, or a sun-visor; or a carpet; or a door card: or a shelf lining: or a glove-box lid; or a fascia cover; or a grab handle; or a centre console; or another interior trim component.

In a different example (not shown) the cover or a portion thereof may be for an exterior trim component such as; a soft top for the roof of a vehicle; a flexible skirt; or the exterior pillar trim; or the exterior window surround; or any other exterior trim component.

In another example (not shown) a different interior trim component such as: headlining, or an interior pillar, or a sun-visor; or a carpet; or a door card: or a shelf lining: or a glove-box lid; or a fascia cover; a grab handle; or a centre console; or another interior trim component for a vehicle may comprise a cover or a portion thereof of the present invention.

In a further example (not shown) an exterior trim component such as one or more of; a soft top for the roof of a vehicle; a flexible skirt; an exterior pillar trim; an exterior window surround; and any other exterior trim component comprises an automotive cover or a portion thereof of the present invention.

The soft top for a roof of a vehicle may comprise one or more of: the exterior pillar trim; the exterior window surround; and any other exterior trim component. For example (not shown) wherein the vehicle is a cabriolet vehicle with a soft top that is foldable and/or removable.

In another example (not show) the soft top for a roof of a vehicle may be applied onto a solid roof.

In another example (not shown) a vehicle may be usable for camping, with the lid of the roof of the vehicle comprising a solid panel, and a different exterior trim component in the form of a flexible skirt that is coupled between the lid of the roof and the main body of the vehicle.

In another example a vehicle may comprise a cover or a portion thereof of the present invention comprising one or more of: a headlining, or an interior pillar, or a sun-visor; or a carpet; or a door card: or a shelf lining: or a glove-box lid; or a fascia cover; or a grab handle; or a centre console; or another interior trim component which comprises an automotive cover or a portion thereof of the present invention, and/or an exterior trim component such as soft top for a roof of a vehicle; or a flexible skirt; and/or any other exterior trim component.

The method 500 as described hereinbefore is illustrated in FIG. 9 in which features of embodiments of the method according to the present invention are shown. In an embodiment the method comprises forming a 3D knitted structure at step 510 and applying a heat treatment process at step 520 to form or fabricate a cover as hereinbefore described. In an embodiment the method additionally comprises applying a tensile force at step 512 to the 3D knitted structure prior to and then during the heat treatment process at step 520. Step 512 is illustrated in dashed line to indicate that it is not used in the embodiment of the method 500 as first described.

1-15. (canceled)

16. A method of fabricating a cover for an interior trim component or an exterior trim component for a vehicle comprising:
forming a 3D knitted structure by knitting together at least one heat activated yarn and at least one non-heat activated yarn, the 3D knitted structure comprising at least one integrally formed 3D knitted channel comprising a substantially continuous loop of knitted material, the channel being arranged to: receive a vehicle component inserted into the channel from an end thereof; and hold the vehicle component within the continuous loop of knitted material; and
applying a heat treatment process to the 3D knitted structure to form the cover.

17. A method according to claim 16, wherein at least one of said at least one channel is in the form of a plurality of spaced channel portions.

18. A method according to claim 16, wherein at least one of said at least one channel is on an underside of the cover.

19. A method according to claim 16, comprising providing an electrical or optical cable through at least one said at least one channel.

20. A method according to claim 16, comprising providing a structural element through at least one of said at least one channel and securing the structural element to a portion of a vehicle structure whereby the structural element is arranged to apply a tensile force to the cover.

21. A method according to claim 16, comprising mounting the cover to a former such that the cover assumes a required shapeform, the method comprising performing the heat treatment process with the cover mounted to the former.

22. A method according to claim 21, comprising holding at least a portion of the cover in a required position by a grip or clamp during the heat treatment process.

23. A method as claimed in claim 22, the method comprising applying the tensile force to the cover during the heat treatment process by applying a tensile force to the structural element.

24. A method according to claim 16, comprising forming the cover to have an elongate rib portion, whereby the cover has a greater thickness along the rib portion.

25. A cover comprising a 3D knitted structure, the 3D knitted structure comprising at least one heat activated yarn and at least one non-heat activated yarn knitted together; and at least one integrally formed 3D knitted channel comprising a substantially continuous loop of knitted material, the channel being arranged to receive a vehicle component inserted into the channel from an end thereof, and hold the vehicle component within the continuous loop of knitted material.

26. The cover according to claim 25 fabricated by the method of claim 1.

27. An interior trim component comprising at least one automotive cover according to claim 25.

28. The interior trim component of claim 27, wherein the interior trim component is one of: a seat cover, a fascia cover, a headlining, an interior pillar trim, a sun-visor; a carpet; a door card; a shelf lining; a glove-box lid; a grab handle; and a centre console.

29. An exterior trim component comprising at least one cover according to claim 25, and optionally wherein the exterior vehicle trim component is one or more of: a soft top for a roof of a vehicle; an exterior pillar trim; an external window surround; and another exterior trim component.

30. A vehicle having at least one automotive cover according to claim 25.

31. A vehicle having at least one interior trim component according to claim 27.
